(19) United States
(12) Patent Application Publication
(10) Pub. No.: US 2025/0315836 A1
(43) Pub. Date: Oct. 9, 2025

(54) METHOD AND APPARATUS OF PROVIDING TRACKING RESULTS OF DIGITAL ASSETS

(71) Applicant: Dunamu Inc., Seoul (KR)

(72) Inventors: Seongyong Kim, Seoul (KR); Joochan Shin, Seoul (KR); Taehwan Kim, Seoul (KR); Minseob So, Seoul (KR); Jaein Kim, Seoul (KR); Sudong Choi, Seoul (KR)

(21) Appl. No.: 19/078,856

(22) Filed: Mar. 13, 2025

(30) Foreign Application Priority Data
Apr. 4, 2024 (KR) 10-2024-0046241

(51) Int. Cl. G06Q 20/40; G06Q 20/36

(52) U.S. Cl. CPC G06Q 20/4016; G06Q 20/36

(57) ABSTRACT

A method for providing a tracking result of a digital asset, performed by at least one processor, may include acquiring information associated with a first transaction that corresponds to a transfer of a first target asset from a first wallet to a second wallet, outputting a first node corresponding to the first wallet, a second node corresponding to the second wallet, and a first edge corresponding to the first transaction, outputting a second edge corresponding to a second transaction among one or more transactions that correspond to one or more transfers of an asset from the second wallet to a different wallet, and outputting a third node corresponding to a third wallet that is a recipient of the second transaction, wherein the second transaction is determined to correspond to a transfer of a second target asset associated with at least a portion of the first target asset.

### CROSS-REFERENCE TO RELATED APPLICATION

This application claims priority to Korean Patent Application No. 10-2024-0046241, filed in the Korean Intellectual Property Office on Apr. 4, 2024, the entire contents of which are hereby incorporated by reference.

### BACKGROUND

### Field

The present disclosure relates to a method and an apparatus of providing tracking result of digital asset. The present disclosure relates to a method and an apparatus of providing tracking result of digital asset, which output a node corresponding to a digital wallet associated with a target digital asset and an edge corresponding to a transaction inferred to request a transfer of the target digital asset on a user interface.

### Discussion of The Background

Recently, as investments and transactions using digital assets are actively performed, new types of crimes such as money laundering and hacking using digital assets are frequently committed. In order to deal with such crimes, it is necessary to track and monitor the paths through which digital assets used in crimes are transferred.

However, due to the characteristics of digital assets, it is difficult for a user who has insufficient knowledge on a blockchain field to directly track digital assets used in crimes. Even if the user has knowledge related to the blockchain field, as the complexity of the paths through which digital assets are transferred increases, tracking digital assets used in crimes requires considerable time or a possibility of human error occurring increases. Moreover, as the digital assets used in crimes are divided into smaller amounts and transferred to other digital wallets, as numerous repetitive behaviors such as wash trading occur, or laundering of the digital assets are performed through smart contract, the accuracy of tracking digital assets decreases and more time and efforts are required for tracking.

In this context, considering characteristics of digital asset-based crimes, in which a specific digital wallet in a blockchain network is frequently used repeatedly for the criminal behavior, the tracking method in the related art may fail to promptly track a digital wallet used in crimes at an early stage, which may critically hinder early crime response. Therefore, it is required to adopt a new tracking method that can effectively track digital assets used in crimes, in response to emerging crimes involving digital assets.

### Summary

At least some of the content disclosed in the present specification provides a technology capable of effectively tracking a transfer path of digital assets.

At least some of the content disclosed in the present specification provides a technology capable of easily grasping tracking results of a transfer path of digital assets.

The present disclosure provides a method of providing tracking results of digital assets and computer program and apparatus (system) stored in a recording medium.

Technical challenges of the content disclosed in the present specification are not limited to those described above, and other technical challenges not mentioned above will be clearly understood by a person having ordinary knowledge in the technical field to which the present disclosure belongs from the following description.

The present disclosure may be realized in various ways including a method, a system (apparatus), or a computer program stored in a computer-readable storage medium.

A method for providing a tracking result of a digital asset, performed by at least one processor, according to one or more embodiments of the present disclosure, may include acquiring information associated with a first transaction that corresponds to a transfer of a first target digital asset from a first digital wallet to a second digital wallet, outputting, based on the information associated with the first transaction, a first node corresponding to the first digital wallet, a second node corresponding to the second digital wallet, and a first edge corresponding to the first transaction via a user interface, outputting, via the user interface, a second edge corresponding to a second transaction satisfying a predetermined condition among one or more transactions that correspond to one or more transfers of a digital asset from the second digital wallet to a digital wallet different from the second digital wallet, and outputting, via the user interface, a third node corresponding to a third digital wallet that is a recipient of the second transaction, wherein the second transaction may be a transaction determined to correspond to a transfer of a second target digital asset associated with at least a portion of the first target digital asset.

According to one or more embodiments of the present disclosure, acquiring the information associated with the first transaction may include receiving, via the user interface, a user input that includes the information associated with the first transaction.

According to one or more embodiments of the present disclosure, the second transaction may be a transaction determined by a machine learning model, by inputting a feature of the third digital wallet into the machine learning model, to transfer a digital asset associated with at least a portion of the first target digital asset to the third digital wallet, and the machine learning model may be trained to receive a feature regarding a particular recipient that receives a digital asset through a particular transaction from a sender holding a tracking target digital asset and to output an inference result determining whether the particular transaction corresponds to a transfer of a digital asset associated with at least a portion of the tracking target digital asset, based on the feature regarding the particular recipient.

According to one or more embodiments of the present disclosure, the feature indicating the particular recipient may include information regarding at least one of a quantity of a digital asset transferred to the particular recipient, a quantity of a digital asset transferred from the particular recipient to another digital wallet, an occurrence time of a transaction that corresponds to transferring a digital asset to the another digital wallet, a type of a digital asset transferred by or transferred to the particular recipient, or whether the particular transaction is an external transaction.

According to one or more embodiments of the present disclosure, the machine learning model may be further trained to output a feature attribution that corresponds to an extent to which the feature regarding the particular recipient contributes to the inference result, and outputting, via the user interface, a feature of the third digital wallet that has a feature attribution output by the machine learning model may be performed, wherein the feature attribution of the output feature of the third digital wallet satisfies a threshold.

According to one or more embodiments of the present disclosure, outputting the feature of the third digital wallet may include outputting, via the user interface, the feature attribution satisfying the threshold of the feature of the third digital wallet, together with the feature of the third digital wallet. According to one or more embodiments of the present disclosure, in response to determining that the third digital wallet is an exchange hot digital wallet, tracking of the digital asset may be stopped for a digital asset transfer path that includes the third digital wallet.

According to one or more embodiments of the present disclosure, whether the third digital wallet corresponds to the exchange hot digital wallet may be determined based on category information of the third digital wallet, and the category information of the third digital wallet may be determined by using a data set that includes a plurality of reference digital wallets and category information regarding each of the plurality of reference digital wallets.

According to one or more embodiments of the present disclosure, in response to determining that a number of transactions per unit time, in which the third digital wallet is a recipient or a sender, is at or above a threshold, the third digital wallet may be determined to be an exchange hot digital wallet.

According to one or more embodiments of the present disclosure, outputting, via the user interface, an occurrence time of the first transaction and an amount of the first target digital asset on the first edge, and outputting, via the user interface, an occurrence time of the second transaction and an amount of the second target digital asset on the second edge may be performed.

According to one or more embodiments of the present disclosure, the second transaction may include a plurality of transactions, and outputting, via the user interface, a number of the plurality of transactions on the second edge, receiving, via the user interface, a user input that selects the second edge, outputting, via the user interface, a plurality of sub-edges associated with the plurality of transactions in response to receiving the user input, and outputting, via the user interface, an occurrence time and a transfer amount of each of the plurality of transactions on each of the plurality of sub-edges may be performed.

According to one or more embodiments of the present disclosure, receiving, via the user interface, a user input that selects the third node, and outputting, via the user interface, an activation indicator corresponding to a trading activity level of the third digital wallet in response to receiving the user input that selects the third node may be performed.

According to one or more embodiments of the present disclosure, the activation indicator may be determined based on a number of transactions, in which the third digital wallet is a recipient or a sender, occurring in each of a plurality of time intervals, and a higher weight may be assigned to the number of transactions in a time interval closer to a current time point among the plurality of time intervals.

According to one or more embodiments of the present disclosure, receiving, via the user interface, a user input that requests summary information of a digital asset transfer path of the first target digital asset, and outputting, via the user interface, a list enumerating digital wallet information on one or more digital asset transfer paths along which the first target digital asset has been transferred in response to receiving the user input that requests the summary information may be performed.

According to one or more embodiments of the present disclosure, in response to determining that no transaction that corresponds to a transfer of digital assets from the third digital wallet to a digital wallet different from the third digital wallet exists, tracking of the digital asset may be stopped for a digital asset transfer path that includes the third digital wallet, and whether a third transaction occurs may be monitored, the third transaction corresponds to a transfer of a third target digital asset associated with at least a portion of the second target digital asset from the third digital wallet to a digital wallet different from the third digital wallet, and outputting, via the user interface, a third edge corresponding to the third transaction and a fourth node corresponding to a fourth digital wallet that is a recipient of the third transaction in response to determining, through the monitoring, that the third transaction has occurred may be performed.

According to one or more embodiments of the present disclosure, receiving, via the user interface, a user input associated with a fourth transaction that corresponds to a transfer of a digital asset from the first digital wallet, the second digital wallet, or the third digital wallet to a fifth digital wallet, and determining that the digital asset transferred to the fifth digital wallet through the fourth transaction is associated with at least a portion of the first target digital asset in response to receiving the user input associated with the fourth transaction may be performed.

According to one or more embodiments of the present disclosure, outputting, based on the received user input, via the user interface, a fourth edge corresponding to the fourth transaction and a fifth node corresponding to the fifth digital wallet may be performed.

According to one or more embodiments of the present disclosure, information associated with the fourth transaction may be included in training data for a machine learning model after being assigned a correct label corresponding to a transaction that requests transferring a tracking target digital asset, and the machine learning model may be trained to receive a feature regarding a particular recipient that receives a digital asset through a particular transaction from a sender holding the tracking target digital asset and to output an inference result determining whether the particular transaction corresponds to a transfer of at least a portion of the tracking target digital asset, based on the feature regarding the particular recipient.

A non-transitory computer-readable recording medium storing instructions for executing the method according to one or more embodiments of the present disclosure may be provided.

A computing device according to one or more embodiments of the present disclosure, may include a memory and at least one processor coupled to the memory and executing at least one computer-readable program contained in the memory, wherein the at least one computer-readable program may be configured, when executed by the at least one processor communicating with the memory, to cause the computing device to perform acquiring information associated with a first transaction, outputting a first node, a second node, and a first edge via a user interface, outputting a second edge and a third node, and determining a transaction corresponding to a transfer of a second target digital asset associated with at least a portion of the first target digital asset.

According to some embodiments of the present disclosure, a user can check a transfer path of a target digital asset, information associated with a digital wallet on the transfer path, and information associated with a transaction in one screen, and thus can easily grasp tracking results of the target digital asset within a short time.

According to some embodiments of the present disclosure, even if swap or cross-chain of the target digital asset is performed, tracking of digital assets of which identity to the target digital asset is maintained may be continuously proceeded.

According to some embodiments of the present disclosure, a user can easily distinguish an object to be focused on from another object in a digital asset tracking graph and recognize thereof.

According to some embodiments of the present disclosure, by performing a tracking process of a target digital asset using a machine learning model, reduced time and efforts are required for a user in tracking the target digital asset, and human error is prevented to improve tracking accuracy.

According to some embodiments of the present disclosure, a user can take a multilateral review of a transfer path of the target digital asset by directly adding a suspicious transaction in addition to a transaction determined to request a transfer of the target digital asset by the machine learning model.

According to some embodiments of the present disclosure, a user can acquire and process information associated with a transaction involved in crimes and the like in a format that is easily utilized as a proof material and the like.

Effects of the present disclosure are not limited to the effects that are mentioned above, and other effects that are not mentioned will be clearly understood by a person having ordinary knowledge in the technical field to which the present disclosure belongs (hereinafter, referred to as “person skilled in the art”) from the claims.

### BRIEF DESCRIPTION OF THE DRAWINGS

These embodiments of the present disclosure will be described with reference to the accompanying drawings to be described below, and like reference numbers herein represent like elements, but are not limited thereto.

FIG. 1 is a view illustrating an example of outputting a digital asset tracking graph via a user interface.

FIG. 2 is an outline view illustrating an example in which an information processing system is connected to communicate with a plurality of user terminals, in order to provide a service of providing tracking results of digital assets.

FIG. 3 is a block diagram illustrating an example of internal configurations of a user terminal and an information processing system.

FIG. 4 is a view illustrating an example of a user interface to receive information associated with a transaction.

FIG. 5 is a view illustrating input data and output data of a machine learning model used for a tracking process of a target digital asset.

FIG. 6 is a view illustrating an example of an artificial neural network model used for a tracking process of a target digital asset.

FIG. 7 is a flowchart illustrating an example of a method of determining a digital asset transfer path of a target digital asset.

FIG. 8 is a view illustrating an example of a user interface to add a specific transaction as a part of tracking results.

FIG. 9 is a view illustrating an example of a user interface outputting summary information of a digital asset tracking graph.

FIG. 10 is a view illustrating an example of a user interface generating a node.

FIG. 11 is a view illustrating an example of a user interface displaying information associated with a specific digital wallet.

FIG. 12 is a view illustrating an example of a user interface displaying a list of transactions associated with a specific digital wallet.

FIG. 13 is a view illustrating an example of a user interface displaying a feature that is a basis of inference results of a machine learning model.

FIG. 14 is a flowchart illustrating a method of providing tracking results of digital assets.

### DETAILED DESCRIPTION

Hereinafter, various examples of the present disclosure will be described, in detail, with reference to the accompanying drawings. Specific explanation about well-known functions and elements may be omitted in the description below.

In the drawings, the same or corresponding components are given with the same reference numerals. Moreover, in the description of the following embodiments, overlapping description of the same or corresponding components may be omitted. However, even if some description about the components is omitted, it is not intended that such components are not included in a certain embodiment.

Advantages and features of the disclosed embodiments, and methods to achieve these will be clarified by referring to the accompanying drawings and embodiments described below. However, the present disclosure is not limited to the embodiments disclosed below and can be realized in various different forms, and the present embodiments are provided only to make the present disclosure complete and to make the present disclosure to fully inform a person skilled in the art of the scope of the invention.

A brief description of the terms used in the present specification will be provided, followed by a detailed description of the disclosed embodiments. As for the terms used in the present specification, currently widely used general terms are selected as much as possible considering the functions in the present disclosure, but this may vary by the intention of a person skilled in the art, precedents, or appearance of new technologies. Moreover, in a specific case, there will be terms optionally selected by the applicant, and the meaning will be described in detail in the section of the description corresponding to this. Therefore, the terms used in the present disclosure should not be defined by the simple name of the terms but based on the meanings of the terms and the overall content of the present disclosure.

As used herein, the singular forms include the plural forms as well, unless the context clearly indicates otherwise. Moreover, the plural forms include the singular forms as well, unless the context clearly indicates otherwise. When a part of the overall specification includes a certain component, this means that other components may be further included, rather than excluded, unless particularly described otherwise.

Moreover, the term “module” or “unit” used in the specification means a software or hardware component, and the “module” or “unit” performs certain roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

According to one or more embodiments of the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, it is said that the memory is in a state of electronic communication with a processor. Memory integrated into a processor is in a state of electronic communication with the processor.

In the present disclosure, the “system” may include at least one device among a server device and a cloud device, but is not limited thereto. For example, the system may include (or configured with) one or more server devices. As another example, the system may include (or configured with) one or more cloud devices. As another example, the system may operate by a server device and a cloud device.

Moreover, terms such as first, second, A, B, (a), and (b) used in the embodiments below are used only to distinguish one component from other components, but these terms do not limit nature, order, sequence, or the like of the components.

Moreover, in the embodiments below, when a component is referred to as being “linked”, “coupled”, or “connected” to another component, the components may be directly “coupled”, “linked”, or “connected” to each other, but it should be understood that another component may be “linked”, “coupled”, or “connected” between each component.

Moreover, the terms “comprises” or “comprising” used in the embodiments below specify the presence of mentioned components, steps, operations, or elements but do not preclude the presence or addition of one or more other components, steps, operations, or elements.

In the present disclosure, “each of a plurality of A” may refer to “each of all components included in a plurality of A, or may refer to each of some components included in the plurality of A.

In the present disclosure, “or” should be understood to represent that all combinations of a plurality of elements linked through the “or” are allowed unless described otherwise. For example, “A or B” may include “A”, “B”, and “A and B”, and “A, B, or C” may include “A”, “B”, “C”, “A and B”, “B and C”, “A and C”, and “A, B, and C”.

Before describing various embodiments of the present disclosure, the terms used herein are described.

In the present disclosure, “information associated with X” and “X information” may be used interchangeably with the same meaning.

In the present disclosure, the “user” may refer to an individual that uses a service provided based on various embodiments of the present disclosure, such as a service of providing tracking results of digital assets.

In the present disclosure, the “digital asset” or “asset” may refer to a digital asset encrypted by using a blockchain technology, such as a cryptocurrency, a non-fungible token (NFT), or the like.

In the present disclosure, the “target digital asset” is not necessarily limited to a digital asset used in crimes, and may refer to a digital asset that is subject to digital asset flow tracking. For example, the “target digital asset” may refer to a digital asset that is transferred by a transaction or digital wallet initially selected as a tracking target, or to a portion of the digital asset after being split. In another example, the “target digital asset” may refer to a digital asset obtained by converting (or, modifying) the digital asset that is subject to digital asset flow tracking a digital asset flow through a swap or cross-chain process.

In the present disclosure, the “digital wallet” may refer to a means on a blockchain network for storing a digital asset. The digital asset may be transferred to another digital asset from a specific digital wallet. The “digital wallet” may include various types of digital wallets such as a hot digital wallet, a cold digital wallet, a personal digital wallet, a digital wallet for deposit given to an individual at an exchange, and a digital wallet for performing a swap or cross-chain transactions.

In the present disclosure, the “recipient” may refer to a digital wallet that receives a specific digital asset through a transaction, and the “sender” may refer to a digital wallet that transfers a specific digital asset to a recipient through a transaction.

In the present disclosure, the “transaction” may refer to a unit of operation for performing one logical function that modifies the state of a blockchain or a block, or may refer to information or data included in such a unit. For example, a transaction corresponding to a transfer of digital assets may include an instruction that calls a function for performing a digital asset transfer included in a smart contract, and the above-described instruction may include at least one of a sender digital wallet address or a recipient digital wallet address.

In the present disclosure, the “user interface” is not limited to refer to a single screen displayed on a display such as a user terminal, and may refer to one or more screens including a window, an icon, a button or a menu such that a user is provided with information or interact with the system. A specific configuration of the user interface illustrated in each drawing is provided as an example for explanation and the present disclosure is not limited thereto. For example, any graphical object or a graphic element different from the illustrated one may be used.

In the present disclosure, the “path”, “transfer path”, or “digital asset transfer path” may refer to a path through which a specific digital asset or a target digital asset is transferred, and may refer to a path on one or more blockchain networks or a path on a digital asset tracking graph output (e.g., displayed) on the user interface.

In the present disclosure, the “digital asset tracking graph” may refer to a graph output (e.g., displayed) on the user interface to display tracking results of a target digital asset. The digital asset tracking graph may be a group of a plurality of paths.

In the present disclosure, the “node” and “edge” are basic units constituting a digital asset tracking graph, the “node” may refer to an arbitrary graphic object corresponding to a digital wallet, and the “edge” may refer to an arbitrary graphic object corresponding to a transaction between any two digital wallets.

Hereinafter, various embodiments of the present disclosure are described in detail with reference to the accompanying drawings.

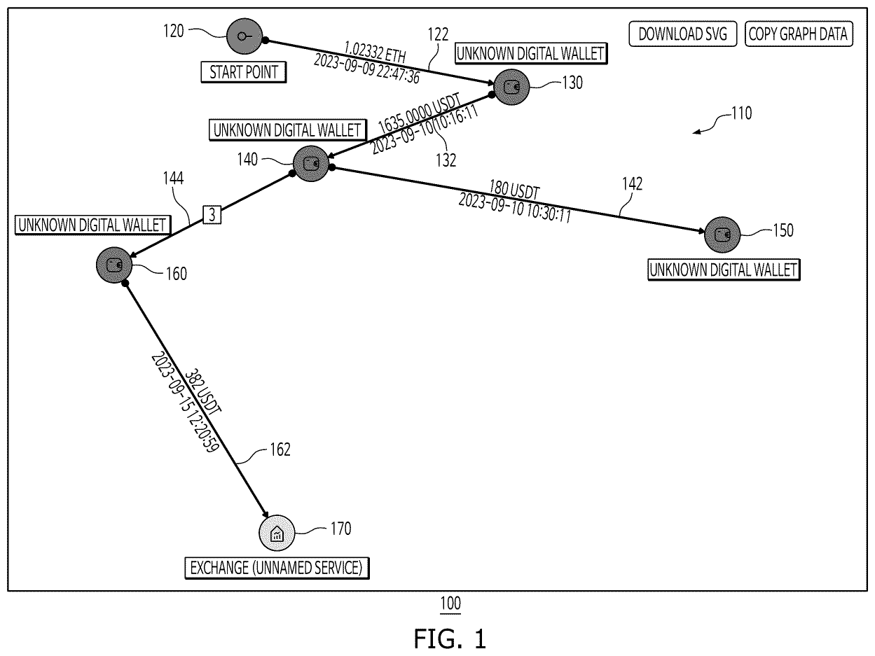

FIG. 1 is a diagram illustrating an example in which a digital asset tracking graph 110 is output via a user interface 100. The digital asset tracking graph 110 may include nodes 120, 130, 140, 150, 160, 170 and edges 122, 132, 142, 144, 162. Each of the nodes 120, 130, 140, 150, 160, 170 may correspond to a digital wallet that currently holds or has previously held at least part of a target digital asset. Each edge 122, 132, 142, 144, 162 may correspond to a transaction that requests the transfer of at least a portion of the target digital asset.

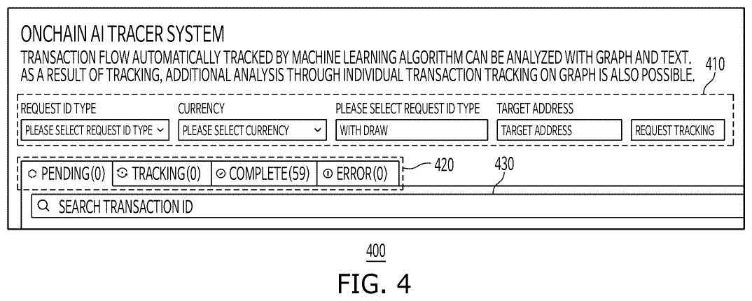

A first digital wallet corresponding to a first node 120 may be a digital wallet that transfers a first target digital asset to a second digital wallet corresponding to a second node 130 through a first transaction corresponding to a first edge 122. For example, the first transaction may include an instruction for executing a function in a smart contract that transfers the first target digital asset from the first digital wallet to the second digital wallet. The first transaction may be a transaction initially selected by a user as a target for digital asset tracking. The first transaction may be specified and selected on the basis of a user input that includes information associated with the first transaction. For example, the first transaction may be specified on the basis of a user input including identification information for the first transaction, such as an ID (e.g., TXID) of the first transaction. Detailed explanations will be provided below with reference to FIG. 4.

A second transaction corresponding to a second edge 132 may be a transaction among one or more transactions that request transferring a digital asset from the second digital wallet to another digital wallet, and the second transaction may satisfy a predetermined condition. In one example, the second transaction corresponding to the second edge 132 may be a transaction that is determined to request transferring a second target digital asset associated with at least a portion of the first target digital asset to a third digital wallet corresponding to a third node 140.

Similarly, a third transaction corresponding to a third edge 142 may be a transaction that is determined to request transferring a third target digital asset associated with at least a portion of the second target digital asset to a fourth digital wallet corresponding to a fourth node 150.

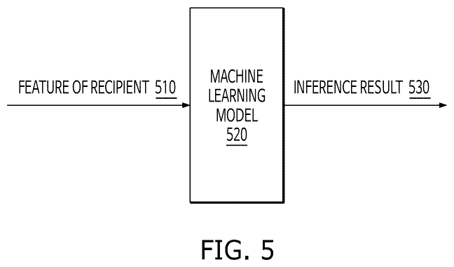

An inference regarding a particular transaction may be performed by inputting features regarding a recipient of the transaction into a machine learning model. Specific configurations related to the machine learning model that performs inference regarding a particular transaction will be described below in detail with reference to FIGS. 5 through 7.

Likewise, a fourth edge 144, a fifth node 160, a fifth edge 162, and a sixth node 170 in the digital asset tracking graph 110 may each correspond to a transaction and a digital wallet determined as a result of a recursive inference process similar to the one described above.

Information associated with each node 120, 130, 140, 150, 160, 170 may be further displayed. For example, for each node 120, 130, 140, 150, 160, 170, addresses, types, balances, owners, activation indicators, and/or whether each corresponding digital wallet is an exchange digital wallet or a contract address may be displayed along with other relevant details.

Information associated with a node may be displayed using graphics such as text, images, icons, or colors. For example, in FIG. 1, the first node 120, which corresponds to the digital wallet to which the target digital asset is first transferred, is displayed using an icon and the text “Start Point.” Additionally, the sixth node 170, which corresponds to a digital wallet associated with a swap of the target digital asset, is displayed using an icon and the text “Exchange.”

Information associated with each edge 122, 132, 142, 144, 162 may be displayed. For example, each edge 122, 132, 142, 144, 162 may display information such as identification information, the number of transactions, occurrence time, type or amount of transferred digital asset associated with the transaction corresponding to each edge 122, 132, 142, 144, 162. The identification information for a transaction may include a transaction ID (TXID).

Information associated with an edge may be displayed using graphics such as text, images, icons, or colors. For example, on the first edge 122, the second edge 132, the third edge 142, and the fifth edge 162, the type (ETH, USDT), transfer amount, and occurrence time of the transferred digital asset are shown.

In one example, when a plurality of transactions is used to transfer a target digital asset from a particular digital wallet to another digital wallet, the number of transactions in which the target digital asset is transferred may be displayed. For example, “3” may be displayed on the fourth edge 144 in FIG. 1. In response to a user input selecting the edge that indicates the number of a plurality of transactions, a plurality of sub-edges associated with the plurality of transactions may be output. For instance, when a user selects the fourth edge 144, three sub-edges may be displayed. For each sub-edge, information associated with that sub-edge may be displayed, such as identification information of the corresponding transaction, quantity, occurrence time, or type or amount of the transferred digital asset. The identification information for a transaction may include a transaction ID (TXID).

Through this arrangement, a user may confirm the transfer path of a target digital asset, information associated with digital wallets within the transfer path, and information associated with transactions in the same screen, thereby quickly and easily understanding the tracking result of the target digital asset.

A user may change the visualization method of the digital asset tracking graph 110. In one example, a user may drag a particular node within the digital asset tracking graph 110 to a desired location and thereby modify the shape of the digital asset tracking graph 110. In another example, a user may enlarge or reduce the size of the digital asset tracking graph 110.

A user may highlight at least some of the nodes in the digital asset tracking graph 110, at least some of the edges, or at least some of the paths. For example, in response to the user selecting a particular node or a particular edge in the digital asset tracking graph 110, a path proceeding from the selected node or edge may be highlighted. For instance, when the user selects the third node 140, the path including the third node 140, the fourth edge 144, the fifth node 160, the fifth edge 162, and the sixth node 170, or the path including the third node 140, the third edge 142, and the fourth node 150, or at least one of those paths, may be highlighted. Through this arrangement, the user may easily identify a target object of interest in the digital asset tracking graph by distinguishing that object from other objects. An object highlighted in the digital asset tracking graph 110 may differ in color, pattern, opacity, size, shape, outline, outline thickness, or outline pattern from other parts that are not highlighted.

A user may change at least some of the objects in the digital asset tracking graph 110 via the user interface 100. In one example, a user may delete a particular node or a particular edge in the digital asset tracking graph 110. In response to the user deleting a particular node or edge, nodes and edges within the path proceeding from the deleted node or edge may also be deleted. For instance, in response to the user deleting the fifth node 160, the fifth edge 162 and the sixth node 170 may be deleted together.

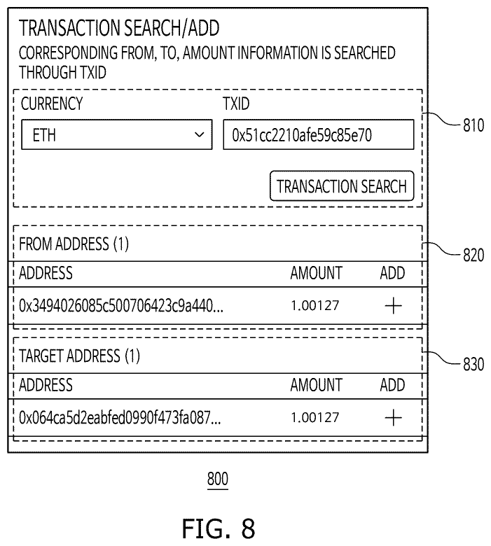

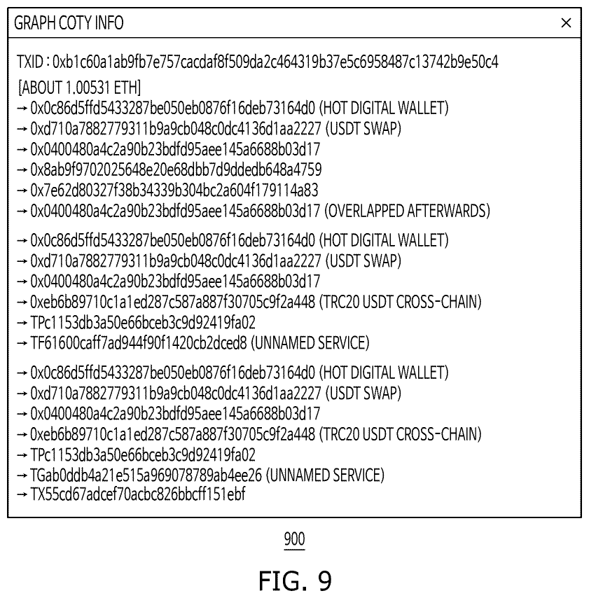

Conversely, a user may add a particular node or a particular edge to the digital asset tracking graph 110. An example in which a user adds a particular node will be described in detail below with reference to FIGS. 8 and 9.

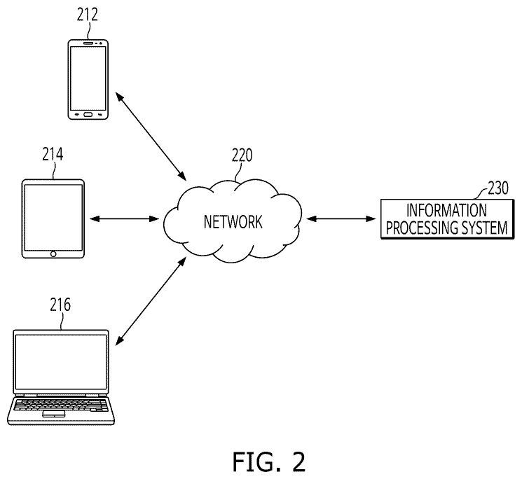

FIG. 2 is a schematic diagram illustrating an example in which an information processing system 230 is connected to allow communication with a plurality of user terminals 212, 214, 216 in order to provide a service for providing tracking results of digital assets. The information processing system 230 may include system(s) capable of providing a service that provides tracking results of digital assets. In one embodiment, the information processing system 230 may include one or more server devices or databases, or one or more distributed computing devices or distributed databases based on a cloud computing service, which are capable of storing, providing, and executing computer-executable programs (e.g., downloadable applications, etc.) and data related to the service for providing tracking results of digital assets.

A service that provides tracking results of digital assets, provided by the information processing system 230, may be provided to users through an application or the like installed on each of the plurality of user terminals 212, 214, 216. The service that provides tracking results of digital assets may denote a service that provides a digital asset tracking graph or similar functionality for a target digital asset.

The plurality of user terminals 212, 214, 216 may communicate with the information processing system 230 through a network 220. The network 220 may be configured so that communication is possible between the plurality of user terminals 212, 214, 216 and the information processing system 230. Depending on the installation environment, the network 220 may be implemented as a wired network such as Ethernet, a wired home network (power line communication), a telephone-line communication device, or RS-serial communication, a mobile communication network, a wireless LAN (WLAN), Wi-Fi, Bluetooth, ZigBee, or a combination thereof. The communication method is not limited thereto, and in addition to a communication method using a communication network included in the network 220 (such as a mobile communication network, wired Internet, wireless Internet, broadcast network, or satellite network), short-range wireless communication between user terminals 212, 214, 216 may also be included.

For example, the plurality of user terminals 212, 214, 216 may transmit requests to the information processing system 230 through the network 220, and the information processing system 230, after receiving those requests, may transmit responses corresponding to the requests to the plurality of user terminals 212, 214, 216. For instance, when the user terminal 212 transmits a user input such as data entry or selection of a specific link to the information processing system 230 (request), the information processing system 230 may transmit data associated with the user input to the user terminal 212 (response). In one example, in response to the user terminal 212 inputting information associated with a particular transaction via a user interface, the information processing system 230 may transmit a digital asset transfer path associated with part or all of the target digital asset transferred by the relevant transaction to the user terminal 212. The user terminal 212 may generate a digital asset tracking graph on the basis of information associated with the digital asset transfer path and may output the digital asset tracking graph via the user interface.

In FIG. 2, the mobile phone terminal 212, the tablet terminal 214, and the PC terminal 216 are illustrated as examples of user terminals, but embodiments are not limited thereto. Each user terminal 212, 214, 216 may be any computing device that can perform wired or wireless communication and run an application or similar program. For example, a user terminal may be a smartphone, a mobile phone, a navigation device, a computer, a laptop, a digital broadcasting terminal, a PDA (personal digital assistant), a PMP (portable multimedia player), a tablet PC, a game console, a wearable device, an IoT (internet of things) device, a VR (virtual reality) device, or an AR (augmented reality) device. Although FIG. 2 illustrates that three user terminals 212, 214, 216 communicate with the information processing system 230 through the network 220, the present disclosure is not limited thereto, and a different number of user terminals may be configured to communicate with the information processing system 230 through the network 220.

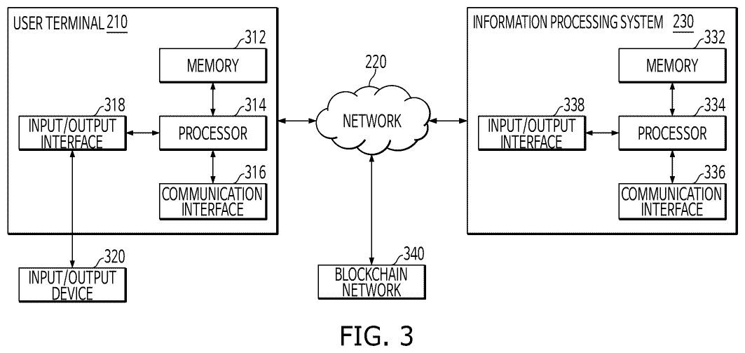

FIG. 3 is a block diagram illustrating an example of the internal configuration of a user terminal 210 and the information processing system 230. The user terminal 210 may be any computing device that can run an application or the like for providing tracking results for digital assets, and that is capable of wired/wireless communication, and for example, may be the mobile phone terminal 212, the tablet terminal 214, or the PC terminal 216 in FIG. 2. As illustrated, the user terminal 210 may include a memory 312, a processor 314, a communication interface 316, and an input/output interface 318. Similarly, the information processing system 230 may include a memory 332, a processor 334, a communication interface 336, and an input/output interface 338. Furthermore, an input/output device 320 may be configured to input information or data into the user terminal 210 or output information or data generated by the user terminal 210 through the input/output interface 318.

As shown in FIG. 3, the user terminal 210 and the information processing system 230 may be configured to communicate information or data through the network 220 using each communication interface 316, 336. The user terminal 210 and the information processing system 230 may be configured to communicate with a blockchain network 340 through the network 220 using each communication interface 316, 336. Alternatively, the blockchain network 340 may communicate only with the information processing system 230 through a separate network different from the network 220 in FIG. 2. In the blockchain network 340, digital assets based on blockchain technology may be mined, recorded, or transferred. Digital assets based on blockchain technology may include Bitcoin or Ethereum, among others. All digital asset transfer history on the blockchain network 340 may be disclosed, and transferring digital assets on the blockchain network 340 may be requested and performed using a transaction.

The memories 312, 332 may each include a non-transitory computer-readable recording medium. According to one embodiment, the memories 312, 332 may include a nonvolatile mass storage device such as a read-only memory (ROM), a disk drive, a solid-state drive (SSD), or a flash memory. As another example, a nonvolatile mass storage device such as a ROM, SSD, flash memory, or disk drive may be a separate permanent storage device distinct from the memory, included in the user terminal 210 or the information processing system 230. The memories 312, 332 may store an operating system and at least one program code (e.g., code for an application that provides tracking results of digital assets).

Such software components may be loaded from a computer-readable recording medium separate from the memories 312, 332. Such a separate computer-readable recording medium may include a recording medium directly connectable to these user terminals 210 and information processing systems 230, for example, a computer-readable recording medium such as a floppy drive, a disk, a tape, a DVD/CD-ROM drive, or a memory card. As another example, software components may be loaded into the memories 312, 332 through the communication interfaces 316, 336 rather than from a computer-readable recording medium. For example, at least one program may be loaded into the memories 312, 332 based on a computer program (e.g., an application for providing tracking results of digital assets) that is installed via files provided by a file distribution system distributing installation files over the network 220.

The processors 314, 334 may be configured to process commands of a computer program by performing basic arithmetic, logical, and input/output operations. The commands may be provided to the processors 314, 334 through the memories 312, 332 or the communication interfaces 316, 336. For example, the processors 314, 334 may be configured to execute commands received according to program code stored in the memories 312, 332 or another recording device.

The communication interfaces 316, 336 may provide a configuration or functionality for the user terminal 210 and the information processing system 230 to communicate with each other through the network 220, and may provide a configuration or functionality for the user terminal 210 or the information processing system 230 to communicate with another user terminal or another system (such as a separate cloud system). A request or data generated by the processor 314 of the user terminal 210 according to a program code stored in a recording device such as the memory 312 may be transmitted to the information processing system 230 through the network 220 under the control of the communication interface 316. Conversely, a control signal or command provided under the control of the processor 334 of the information processing system 230 may be received by the user terminal 210 through the communication interface 336 and the network 220, and received by the user terminal 210 through its communication interface 316.

The input/output interface 318 may be a means for interfacing with the input/output device 320. In one example, an input device may be a device such as a camera that includes an audio sensor or an image sensor, a keyboard, a microphone, or a mouse, and an output device may be a device such as a display, a speaker, or a haptic feedback device. As another example, the input/output interface 318 may be a means for interfacing with a device that integrates configurations or functionalities for both input and output, such as a touchscreen. Although FIG. 3 illustrates the input/output device 320 separately from the user terminal 210, the present disclosure is not limited thereto, and the user terminal 210 may be configured as a single device including the input/output device 320. Additionally, the input/output interface 338 of the information processing system 230 may be a means for interfacing with an input or output device (not shown) that is connected to or included in the information processing system 230. Although FIG. 3 illustrates the input/output interfaces 318, 338 as separate elements from the processors 314, 334, embodiments are not limited thereto, and the input/output interfaces 318, 338 may be configured to be included in the processors 314, 334.

The user terminal 210 and the information processing system 230 may each include more components than the components illustrated in FIG. 3. There is no necessity to specifically illustrate most conventional technical components. In one embodiment, the user terminal 210 may be implemented to include at least some of the aforementioned input/output device(s) 320. Furthermore, the user terminal 210 may further include other components such as a transceiver, a GPS (global positioning system) module, a camera, various sensors, or a database. For example, when the user terminal 210 is a smartphone, the user terminal 210 may typically include components contained in a smartphone, for instance, an accelerometer, a gyro sensor, a microphone module, a camera module, various physical buttons, buttons based on a touch panel, an input/output port, or a vibrator for vibration, among others.

According to one embodiment, the processor 314 of the user terminal 210 may be configured to run an application for providing a service that provides tracking results of digital assets or a web browser application. In that case, program code associated with that application may be loaded into the memory 312 of the user terminal 210. While the application is running, the processor 314 of the user terminal 210 may receive information or data from the input/output device 320 via the input/output interface 318 or from the information processing system 230 via the communication interface 316, and may store the processed information or data in the memory 312. Such information or data may also be provided to the information processing system 230 via the communication interface 316.

While the application is running, the processor 314 may receive audio data, text, images, videos, etc. that are input or selected through an input device such as a touch screen, a keyboard, a camera including an audio sensor or image sensor, or a microphone, connected to the input/output interface 318. The processor 314 may store the received audio data, text, images, videos, etc. in the memory 312 or provide them to the information processing system 230 via the communication interface 316 and the network 220. In one embodiment, the processor 314 may receive, via an input device, a user input selecting a graphic object displayed on the screen, and provide data/requests corresponding to the received user input to the information processing system 230 through the communication interface 316 and the network 220. For example, the processor 314 may receive a user input selecting a particular node in a digital asset tracking graph, and request, from the information processing system 230, an activation indicator representing the transaction activation level of a digital wallet corresponding to the selected node. The information processing system may transmit the activation indicator to the user terminal 210, and the user terminal may output the activation indicator via the user interface.

The processor 314 of the user terminal 210 may transmit information or data to the input/output device 320 via the input/output interface 318, causing those items to be output. For example, the processor 314 of the user terminal 210 may output processed information or data through an output device such as a display that can show visual output (a touch screen or display) or a device that can output audio (a speaker).

The processor 334 of the information processing system 230 may be configured to manage, process, or store information or data received from a plurality of user terminals 210 or from a plurality of external systems. Information or data processed by the processor 334 may be provided to the user terminal 210 through the communication interface 336 and the network 220. For example, the processor 334 may receive information associated with a specific transaction from the user terminal 210, and on the basis of the information, provide the user terminal 210 with a tracking result or a digital asset tracking graph for part or all of the target digital asset transferred by the transaction via the communication interface 336 and the network 220.

The user terminal 210 or the information processing system 230 may be connected to or include a separate database. For example, the user terminal 210 or the information processing system 230 may be connected to, or include, a database containing a plurality of reference digital wallets and category information regarding the plurality of reference digital wallets.

FIG. 4 is a diagram illustrating an example of a user interface 400 for receiving information associated with a transaction. Through a first region 410 of the user interface 400, a user may input information associated with a transaction and request tracking of a target digital asset associated with the transaction. For example, a user may input any information that can specify a transaction, such as identification information of the transaction, a type of digital asset transferred by the transaction, a withdraw ID, or a recipient digital wallet address, in the first region 410. The identification information of the transaction may include a transaction ID (TXID).

In response to the user requesting tracking of the target digital asset through the first region 410, a target digital asset tracking process may be performed using a machine learning model. For example, the target digital asset tracking process may be performed using the machine learning model 520 in FIG. 5, which will be described below.

A user may check information regarding a process that has not yet started tracking, a process that is in progress, a process that has been completed, or a process that has encountered an error, by selecting one among “Pending,” “Tracking,” “Complete,” or “Error” items in a second region 420. A user may check a particular process through a third region 430. For instance, a user may select “Pending” to view a list of processes that have not yet started tracking, and may search for a particular process in that list via the third region 430. More specifically, the user may input identification information of a transaction, such as the transaction ID (TXID), in the third region 430 to search for the tracking process associated with the transaction.

FIG. 5 is a diagram illustrating input data and output data of a machine learning model 520 that is used in a target digital asset tracking process. The machine learning model 520 may be used to infer a digital asset transfer path of a target digital asset.

The machine learning model 520 may receive features 510 regarding a recipient of a transaction subject to inference. In one example, the features regarding the recipient may include at least one of the quantity of digital assets transferred to the recipient, the quantity of digital assets transferred by the recipient to another digital wallet, the occurrence time of transactions that request transferring digital assets from the recipient to another digital wallet, the types of digital assets that the recipient transfers or that are transferred to the recipient, or information regarding whether the transaction subject to inference corresponds to an external transaction.

On the basis of the features 510 regarding the recipient, the machine learning model 520 may output an inference result 530 determining whether the transaction subject to inference requests a transfer of at least a portion of the target digital asset.

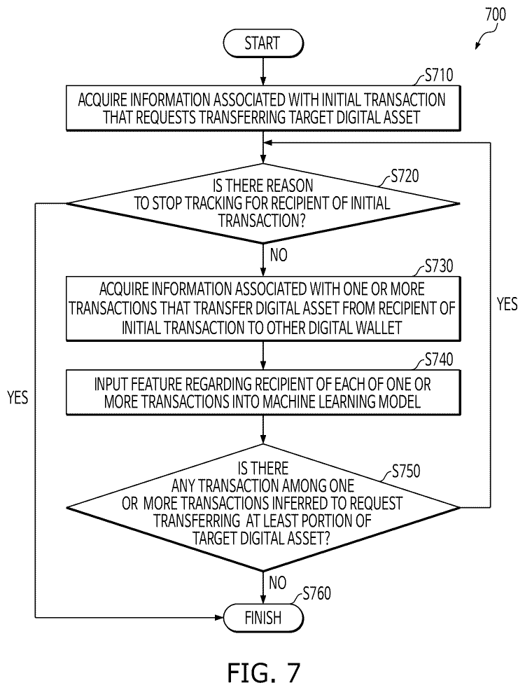

In response to the machine learning model 520 determining that the transaction subject to inference is a transaction that requests the transfer of at least a portion of the target digital asset, the features regarding another recipient who has received a particular digital asset from the recipient of the transaction subject to inference may be input to the machine learning model 520, and an inference result regarding those features may be output. In other words, the inference process of the machine learning model 520 may proceed recursively until a reason for stopping tracking arises. Details regarding this process will be described below with reference to the flowchart of FIG. 7.

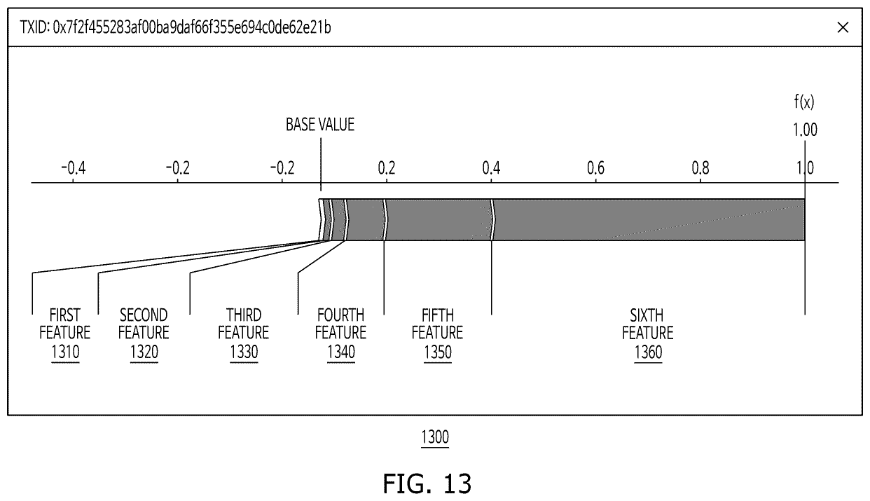

Additionally, the machine learning model 520 may be further trained to output a feature attribution representing the extent to which each feature of the recipient of the transaction subject to inference contributes to the inference result 530. Features that have a feature attribution that is at or above a threshold may be displayed via a user interface. Details regarding this will be described below with reference to FIG. 13.

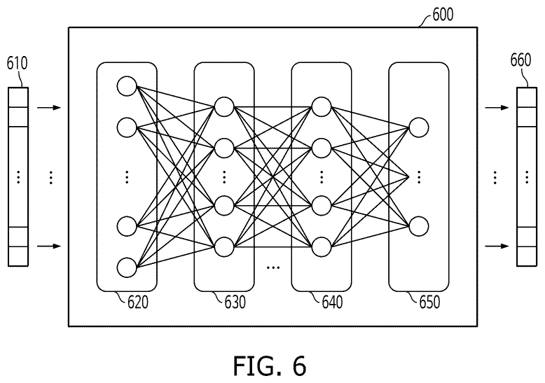

FIG. 6 is a diagram illustrating an example of an artificial neural network model 600 used in a target digital asset tracking process. The artificial neural network model 600 is one example of a machine learning model that may be implemented in the field of machine learning and cognitive science based on the structure of biological neural networks, and is a statistical learning algorithm or a structure for executing that algorithm.

According to one embodiment, the artificial neural network model 600 may denote a machine learning model that acquires problem-solving ability by learning such that the combined weights of artificial neurons (nodes) forming a network through synapse connections repeatedly adjust weights, thereby decreasing the error between a correct output corresponding to a specific input and an inferred output. For example, the artificial neural network model 600 may include any probability model or neural network model used in machine learning or deep learning, among others.

According to one embodiment, the above-described machine learning model may be created as the artificial neural network model 600. For example, the artificial neural network model 600 may be the machine learning model 520 in FIG. 5 and may be a model trained to output an inference result determining whether the transaction subject to inference is a transaction that requests the transfer of at least a portion of the target digital asset, based on features regarding a recipient of the transaction.

The artificial neural network model 600 may be implemented as a multilayer perceptron (MLP) that includes multiple layers of nodes and the connections among those nodes. The artificial neural network model 600 of the present embodiment includes one of a variety of possible artificial neural network structures that contain an MLP. As shown in FIG. 6, the artificial neural network model 600 includes an input layer 620 that receives input signals or data 610 from an external source, an output layer 650 that outputs an output signal or data 660 corresponding to the input data, and n hidden layers 630 through 640 (where n is a positive integer) interposed between the input layer 620 and the output layer 650. The hidden layers 630 through 640 receive signals from the input layer 620, extract features, and transmit signals to the output layer 650. The output layer 650 receives signals from the hidden layers 630 through 640 and outputs those signals externally.

There is a supervised learning method, in which a model learns to optimize for solving a problem through the input of teacher signals (correct answers), and an unsupervised learning method, in which a model does not require teacher signals.

According to one embodiment, the artificial neural network model 600 may be learned through a supervised learning method. For example, the artificial neural network model 600 may extract features by directly tracking digital assets used in an actual crime and learn using training data to which correct labels are assigned for the extracted features. Additionally, in response to a user directly selecting that a particular transaction corresponds to a transaction transferring a target digital asset, a correct label may be assigned to the selected transaction, and the transaction may be included in the training data of the artificial neural network model 600.

According to one embodiment, input variables of the artificial neural network model 600 may include features regarding a particular recipient that receives a particular digital asset through a particular transaction from a sender holding the target digital asset. When such input variables are entered via the input layer 620, output variables output from the output layer 650 of the artificial neural network model 600 may be inference results determining whether the transaction subject to inference is a transaction requesting the transfer of at least a portion of the target digital asset.

Thus, in the artificial neural network model 600, multiple input variables corresponding to multiple output variables may be matched respectively at the input layer 620 and the output layer 650, and synapse values between nodes in the input layer 620, the hidden layers 630 through 640, and the output layer 650 may be adjusted so that a correct output is extracted for a particular input. Through such a learning process, it is possible to identify hidden characteristics in the input variables of the artificial neural network model 600 and adjust synapse values (or weights) between the nodes of the artificial neural network model 600 so that the error between an output variable computed from the input variables and a target output is reduced. Furthermore, the artificial neural network model 600 may learn an algorithm that receives features regarding a recipient as an input, and may learn in a manner that minimizes the loss relative to the above- described inference result (that is, annotation information).

By using the trained artificial neural network model 600, a digital asset transfer path or digital asset tracking graph for a target digital asset may be determined.

FIG. 7 is a flowchart illustrating an example of a method 700 for determining a digital asset transfer path of a target digital asset. The method 700 may be performed by the processor 314 of the user terminal 210 in FIG. 3 or by the processor 334 of the information processing system 230 (hereinafter referred to as the “processor” in the description of FIG. 7).

The method 700 for determining a digital asset transfer path may begin with the processor acquiring information associated with an initial transaction that requests transferring the target digital asset (S710). For example, the information associated with the initial transaction may be acquired from a user input through the user interface of FIG. 4.

On the basis of the information associated with the initial transaction, the processor may determine whether a reason to stop tracking exists for the recipient of the initial transaction (S720).

Whether a reason to stop tracking exists may be determined based on whether information regarding the recipient of the transaction satisfies a certain condition. As an example of a reason to stop tracking, in response to the processor determining that the recipient of the transaction is a hot digital wallet operated by an exchange, the processor may determine that there is a reason to stop tracking for that recipient of the transaction. The hot digital wallet of an exchange may include various types of digital wallets operated by a centralized exchange, a virtual digital asset service provider, or a third-party service provider, such as a hosted digital wallet. Because multiple entities' virtual digital assets are collectively managed in an exchange hot digital wallet, tracking a target digital asset is no longer easy, and the tracking may therefore be stopped.

Conversely, even if the recipient of the transaction is determined to be an exchange hot digital wallet, in response to acquiring information associated with a transaction corresponding to the transfer of at least a portion of the target digital asset from that recipient, the tracking of the target digital asset may not be stopped or may be resumed even if previously stopped.

Whether the recipient of the transaction corresponds to an exchange hot digital wallet may be determined on the basis of category information regarding the recipient of the transaction. For example, the category information for the recipient of the transaction may be determined by using a data set including a plurality of reference digital wallets and category information regarding the plurality of reference digital wallets. As an example, the data set may include category information regarding which digital wallet type (exchange hot digital wallet or personal digital wallet) each of the plurality of reference digital wallets corresponds to. The data set may be stored in a database inside or outside the information processing system or may be identified by calling an API (such as a chainalysis API).

Additionally or alternatively, the processor may determine that a reason to stop tracking exists for the recipient of a transaction if the number of transactions transferring digital assets from the recipient to another digital wallet per unit time is determined to be at or above a threshold. For instance, in response to determining that the sum of the number of transactions per unit time that transfer a digital asset from the recipient and the number of transactions per unit time that transfer a digital asset to the recipient is at or above a threshold, the processor may determine that a reason to stop tracking exists. At this time, the threshold may be arbitrarily set or may be determined on the basis of the number of transactions per unit time of digital wallets already identified or judged to be exchange hot digital wallets. For example, the sum of the number of transactions transferring or receiving a digital asset per unit time may be computed for each digital wallet that is already known or has been determined to be an exchange hot digital wallet, and the minimum value, first quartile (Q1), median (Q2), or average value of values computed for the plurality of exchange hot digital wallets may be set as a threshold.

As another example of a reason to stop tracking, in response to determining that no transaction exists that requests transferring digital assets from the recipient of a transaction to another digital wallet, the processor may determine that there is a reason to stop tracking for the recipient of the transaction.

If, in step S720, it is determined that a reason to stop tracking exists, the tracking of the target digital asset from the transaction is stopped, and determination of the digital asset transfer path that includes the transaction may end (S760).

On the other hand, if, in step S720, it is determined that no reason to stop tracking exists, the processor may acquire information associated with one or more transactions that transfer digital assets from the recipient of the initial transaction to other digital wallets (S730). For example, the processor may acquire identification information for each of the one or more transactions, such as a transaction ID (TXID), and may identify the recipients of each of the one or more transactions.

The processor may input features regarding the recipients of each of the one or more transactions into the machine learning model (S740). Based on the features regarding the recipients, the machine learning model may output inference results as to whether each of the transactions requests transferring at least a portion of the target digital asset. The machine learning model may be the machine learning model 520 of FIG. 5.

The processor may determine whether there exist any transactions among the one or more transactions that are inferred to request transferring at least a portion of the target digital asset (S750).

If, in step S750, it is determined that no transactions exist that request transferring at least a portion of the target digital asset, the tracking of the target digital asset from the transaction is stopped, and the determination of the digital asset transfer path that includes the transaction may end (S760).

When tracking is stopped in step S720 or S750, it may be periodically monitored whether a transaction that requests transferring the target digital asset from the digital wallet for which tracking was stopped occurs. In response to determining that a transaction that requests transferring the target digital asset from that digital wallet has occurred on the blockchain network, the monitoring result may be provided to a user via a pop-up, a guidance message, or a push notification.

Conversely, in response to determining that a transaction that requests transferring at least a portion of the target digital asset exists, steps S720 through S750 may be performed recursively with respect to the determined transaction. For example, the processor may determine whether a reason to stop tracking exists for the recipient of the determined transaction (S720). The same reasons to stop tracking as described above may be applied. The processor may subsequently acquire information associated with one or more transactions transferring digital assets from the recipient of the determined transaction to other digital wallets (S730), input features regarding the recipients of each of the one or more transactions into the machine learning model (S740), and determine whether there exist any transactions that request transferring at least a portion of the target digital asset (S750).

The method 700 may be performed for all digital asset transfer paths that include the initial transaction. By performing the method 700 using a machine learning model, it is possible to track the target digital asset with less time and effort, while preventing human errors, thereby improving tracking accuracy.

Additionally, even if a swap or a cross-chain process is performed for a target digital asset, the tracking may proceed with regard to digital assets that maintain identity with the target digital asset.

FIG. 8 is a diagram illustrating an example of a user interface 800 for adding a particular transaction as part of a tracking result. By inputting information associated with a transaction to be added in a first region 810 of the user interface 800, a user may search for a transaction corresponding to the input information. For example, a user may input the type of digital asset transferred by a transaction and the identification information of the transaction in the first region 810 to search for a transaction corresponding to the input information. The identification information for a transaction may include a transaction ID (TXID).

In response to determining that a transaction corresponding to the input information exists, a second region 820 may display information associated with the sender of the transaction, for example, the address of the sender and the quantity of the transferred digital asset. In response to determining that a transaction corresponding to the input information exists, a third region 830 may display information associated with the recipient of the transaction, for example, the address of the recipient and the quantity of the transferred digital asset.

A user may determine that the searched transaction is a transaction that requests transferring a target digital asset. For example, by selecting the “+” button in the second region 820 or the third region 830, a user may determine that the searched transaction is a transaction that requests transferring a target digital asset.

Hence, in addition or as an alternative to the digital asset tracking process using the machine learning model described above with reference to FIGS. 5 through 7, a user may directly add a particular transaction as part of a tracking result. Through this arrangement, in addition to transactions judged to request transferring a target digital asset by the machine learning model, a user may directly add suspicious transactions and thereby review the transfer path of the target digital asset in a multifaceted manner.

In one example, an edge corresponding to a transaction that the user has added may be added to a digital asset tracking graph (for example, the digital asset tracking graph 110 of FIG. 1), and a node corresponding to the recipient of the added transaction may be added together.

Additionally, by inputting features regarding the recipient of the transaction that the user has added into the machine learning model, for example, the machine learning model 520 of FIG. 5, the digital asset tracking process may begin on the digital asset transfer path that includes the added transaction. Information associated with the user-added transaction may be assigned a correct label corresponding to a transaction that requests transferring the tracking target digital asset, and may be included in the training data for the machine learning model.

FIG. 9 is a diagram illustrating an example of a user interface 900 that outputs summary information of a digital asset tracking graph. The summary information of the digital asset tracking graph may be provided to a user in the form of a list enumerating digital wallet information on one or more digital asset transfer paths to which the target digital asset has been transferred.

Additionally or alternatively, the summary information of the digital asset tracking graph may include identification information of a transaction on one or more digital asset transfer paths, whether the recipient corresponds to an exchange hot digital wallet, the amount of transferred digital assets, whether a digital asset swap is performed, or whether a cross-chain is performed. The identification information of a transaction may include a transaction ID (TXID). Thus, a user may acquire and process information associated with a transaction involved in a crime or the like in a format that can be easily used for evidentiary materials or similar purposes.

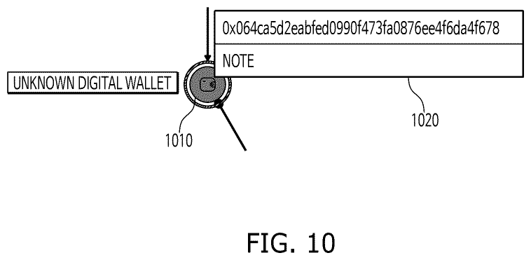

FIG. 10 is a diagram illustrating an example of a user interface 1000 for creating a note. In response to a user selecting an arbitrary node 1010 on the digital asset tracking graph via the user interface, a window 1020 through which the user may compose a note may be displayed on the user interface 1000. A note composed by the user may be displayed together with the selected node 1010 on the digital asset tracking graph.

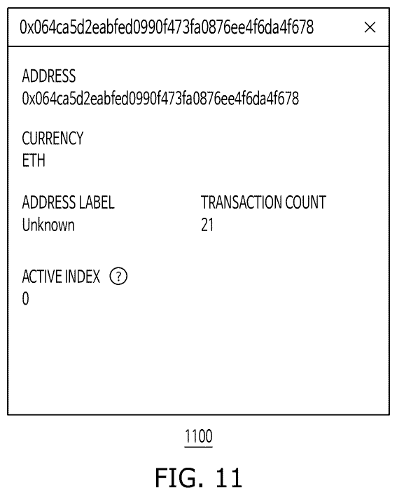

FIG. 11 is a diagram illustrating an example of a user interface 1100 displaying information associated with a particular digital wallet. In response to a user selecting an arbitrary node within a digital asset tracking graph, information associated with the digital wallet corresponding to that selected node may be displayed on the user interface 1100.

The user interface 1100 may display address of the digital wallet (“Address”), the type of digital asset (“Currency”) associated with that digital wallet, the address label of the digital wallet (“Address Label”), the occurrence count of transactions associated with that digital wallet (“Transaction Count”), or an activation indicator (“Active Index”) that indicates the level of trading activity of that digital wallet.

The activation indicator of a digital wallet may be calculated on the basis of the number of transactions in which the digital wallet is a recipient or a sender that occur in each of a plurality of time intervals. In one example, higher weights may be assigned to the number of transactions that occur in a time interval closer to the present moment among the plurality of time intervals.

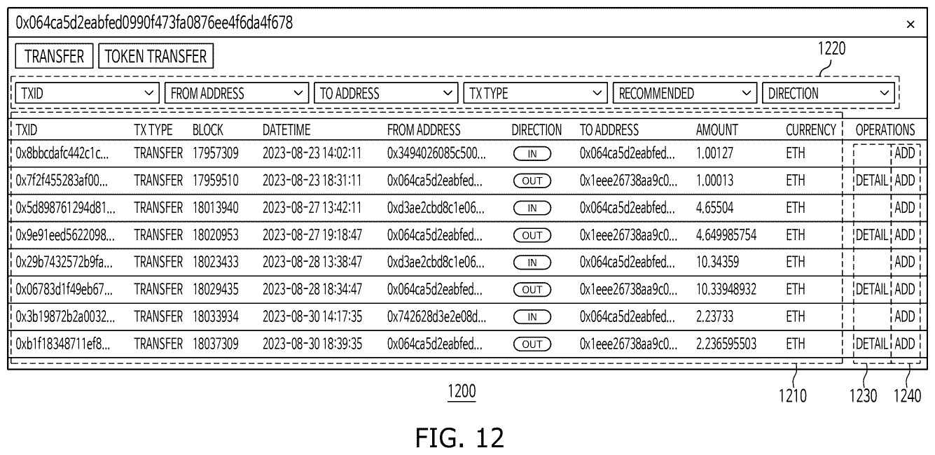

FIG. 12 is a diagram illustrating an example of a user interface 1200 that displays a list of transactions associated with a particular digital wallet. In response to a user selecting an arbitrary node in the digital asset tracking graph, a list of transactions associated with the digital wallet corresponding to that selected node may be displayed on the user interface 1200.

A first region 1210 in the user interface 1200 may display information associated with a transaction that corresponds to the transfer of a digital asset to the digital wallet corresponding to the selected node or a transaction that corresponds to the transfer of a digital asset from the digital wallet of the selected node to another digital wallet. Information associated with a transaction may include identification information of the transaction, a transaction type, the block position of the transaction in the blockchain network, the transaction occurrence time, the sender digital wallet address, the recipient digital wallet address, the digital asset transfer direction, the digital asset amount, or the type of digital asset. The identification information for a transaction may include a transaction ID (TXID). A user may select or input at least some of the transaction-related information in a second region 1220, thereby filtering the information displayed in the first region 1210.

A user may check the basis on which a specific transaction is determined to be a transaction requesting the transfer of a target digital asset. For example, in response to the user selecting “Detail” in a third region, the basis for determining that the transaction displayed in the first region 1210 is a transaction that requests the transfer of a target digital asset may be displayed on the user interface 1200. Details regarding this will be explained below with reference to FIG. 13.

A user may select one or more transactions among the transactions displayed on the user interface to be transactions requesting the transfer of a target digital asset. For example, in response to a user selecting any “Add” button in a fourth region 1240, a transaction corresponding to the user input among those displayed in the first region 1210 may be selected as a transaction requesting the transfer of a target digital asset. Through this arrangement, in addition to transactions that the machine learning model has judged to be transactions requesting the transfer of a target digital asset, a user may directly add suspicious transactions and review the transfer path of the target digital asset in multiple ways.

FIG. 13 is a diagram illustrating an example of a user interface 1300 that displays features on which an inference result of the machine learning model was based. The user interface 1300 of FIG. 13 may be a screen displayed in response to receiving a user input selecting “Detail” in the third region 1230 of FIG. 12.

The machine learning model may output not only an inference result of the machine learning model but also a feature attribution indicating the extent to which each feature input into the machine learning model contributes to the inference result. A feature attribution may be output for each of the plurality of features that are input to the machine learning model.

In one example, names or similar identifications of features whose feature attribution is at or above a threshold may be displayed in the user interface 1300. For instance, the first through sixth features 1310, 1320, 1330, 1340, 1350, 1360 may each be features having a feature attribution at or above a threshold with respect to the inference result indicating that the transaction is determined to correspond to the transfer of the target digital asset. In addition, together with features whose feature attribution is at or above a threshold, the user interface 1300 may further display the feature attributions of those features. A threshold that the feature attribution is compared with may be determined differently for each feature.

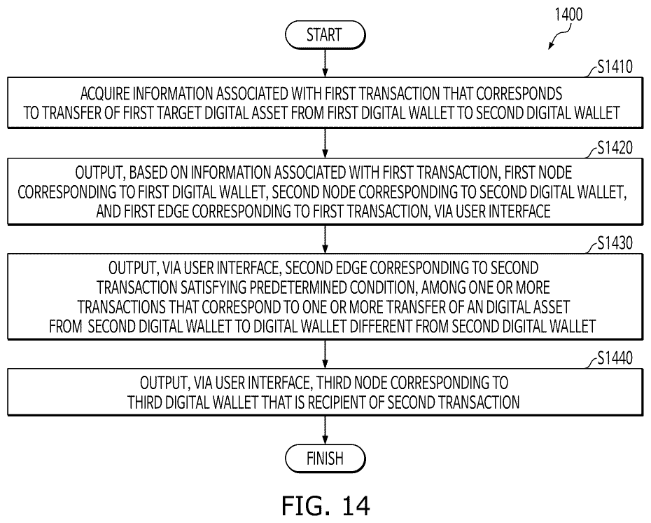

FIG. 14 is a flowchart illustrating a method 1400 of providing tracking results of digital assets. The method 1400 may be performed by at least one processor. For example, the method 1400 may be performed by at least one processor of a user terminal or at least one processor of an information processing system (hereinafter referred to as the “processor” in the description of FIG. 14).

The method 1400 may begin with the processor acquiring information associated with a first transaction that corresponds to a transfer of a first target digital asset from a first digital wallet to a second digital wallet (S1410). In one example, the processor may acquire information associated with the first transaction by receiving, via a user interface, a user input that includes information associated with the first transaction.

On the basis of information associated with the first transaction, the processor may output, via the user interface, a first node corresponding to the first digital wallet, a second node corresponding to the second digital wallet, and a first edge corresponding to the first transaction (S1420). The processor may output at least one of the occurrence time of the first transaction or the amount of the first target digital asset on the first edge.

The processor may output, via the user interface, a second edge corresponding to a second transaction, among one or more transactions that correspond to a transfer of digital assets from the second digital wallet to a digital wallet different from the second digital wallet, that satisfies a predetermined condition (S1430). The second transaction may be a transaction determined to correspond to a transfer of a second target digital asset associated with at least a portion of the first target digital asset.

The processor may output at least one of the occurrence time of the second transaction or the amount of the second target digital asset on the second edge via the user interface. Alternatively, in response to determining that the second transaction includes a plurality of transactions, the processor may display, via the user interface, the number of the plurality of transactions on the second edge, and in response to receiving a user input selecting the second edge via the user interface, the processor may output a plurality of sub-edges associated with the plurality of transactions and output, via the user interface, the occurrence time or transfer amount of each of the plurality of transactions on each sub-edge.

In one example, the second transaction may be a transaction determined by the machine learning model to transfer a digital asset associated with at least a portion of the first target digital asset to a third digital wallet, by inputting features regarding the third digital wallet into the machine learning model. In that case, the machine learning model may be a model trained to receive features regarding a particular recipient from a sender holding a tracking target digital asset through a particular transaction and, on the basis of those features regarding the particular recipient, output an inference result determining whether the particular transaction corresponds to a transfer of a digital asset associated with at least a portion of the tracking target digital asset. The features regarding the particular recipient, input into the machine learning model, may include the quantity of digital assets transferred to the particular recipient, the quantity of digital assets transferred from the particular recipient to another digital wallet, the occurrence time of transactions that correspond to transferring digital assets to another digital wallet, the types of digital assets that the particular recipient transfers or that are transferred to the particular recipient, or information regarding whether the particular transaction is an external transaction.

The machine learning model may be further trained to output a feature attribution (i.e., a contribution level of each feature) that corresponds to the extent to which the features regarding the particular recipient contribute to the inference result. The processor may output, via the user interface, features of the third digital wallet whose feature attributions output by the machine learning model are at or above a threshold. Additionally, the processor may output, via the user interface, the feature attributions of features that are at or above the threshold together with those features.

The processor may output, via the user interface, a third node corresponding to the third digital wallet, which is the recipient of the second transaction (S1440).

In one example, in response to determining that the third digital wallet is an exchange hot digital wallet, the tracking of the digital asset in the digital asset transfer path including the third digital wallet may be stopped. For example, whether the third digital wallet corresponds to an exchange hot digital wallet may be determined on the basis of category information of the third digital wallet, and the category information of the third digital wallet may be determined by using a data set that includes a plurality of reference digital wallets and category information of the plurality of reference digital wallets. Additionally or alternatively, in response to determining that the number of transactions per unit time in which the third digital wallet is a recipient or a sender is at or above a threshold, the third digital wallet may be determined to be an exchange hot digital wallet.

In one example, in response to receiving a user input selecting the third node via the user interface, the processor may output, via the user interface, an activation indicator corresponding to the level of trading activity of the third digital wallet. The activation indicator may be calculated on the basis of the number of transactions in which the third digital wallet is a recipient or a sender in each of a plurality of time intervals. More specifically, among the plurality of time intervals, for a time interval closer to the present time, a higher weight may be assigned to the number of transactions that occur in that time interval for which the third digital wallet is a recipient or a sender.

In one example, in response to receiving a user input requesting summary information about a digital asset transfer path for the first target digital asset via the user interface, the processor may output, via the user interface, a list enumerating digital wallet information on one or more digital asset transfer paths along which the first target digital asset has been transferred.

In one example, in response to determining that no transaction exists for transferring digital assets from the third digital wallet to another digital wallet, the tracking of the digital asset in the digital asset transfer path including the third digital wallet is stopped, and it may be monitored whether a third transaction that corresponds to transferring at least a portion of a second target digital asset associated with the first target digital asset from the third digital wallet to a digital wallet different from the third digital wallet occurs. In response to determining, through the monitoring, that the third transaction has occurred, the processor may output, via the user interface, a third edge corresponding to the third transaction and a fourth node corresponding to the recipient of the third transaction.

In one example, the processor may receive, via the user interface, a user input associated with a fourth transaction that corresponds to a transfer of digital assets from one of the first, second, or third digital wallets to a fifth digital wallet. In response to receiving the user input, the digital asset transferred to the fifth digital wallet through the fourth transaction may be determined to be associated with at least a portion of the first target digital asset. On the basis of the received user input, the processor may output, via the user interface, a fourth edge corresponding to the fourth transaction and a fifth node corresponding to the fifth digital wallet. Information associated with the fourth transaction may, after being assigned a correct label corresponding to a transaction that requests transferring the tracking target digital asset, be included in the training data for the machine learning model.

The flowchart of FIG. 14 and the description above merely illustrate one example, and some embodiments may be implemented differently. For example, one or more steps in FIG. 14 may be omitted, the order of the steps may be changed, one or more steps may be performed in an overlapping manner, or one or more steps may be repeated multiple times.

The above-described method may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

Various methods, operations, or techniques of the present disclosure may be implemented by a variety of means. For example, such techniques may be implemented through hardware, firmware, software, or a combination thereof. A person skilled in the art will understand that the various exemplary logical blocks, modules, circuits, and algorithm steps described in connection with the present disclosure may be implemented with electronic hardware, computer software, or combinations thereof.

Such reciprocal substitution between hardware and software has been generally described above from a functional standpoint. Whether such functionality is implemented as hardware or software depends on the design requirements imposed on the overall system and the particular application. A person of ordinary skill in the art may implement the described functionality in various ways for each specific application, and such implementations must not be interpreted as departing from the scope of the present disclosure.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Therefore, various exemplary logical blocks, modules, or circuits described in connection with the present disclosure may be implemented or performed in a general-purpose processor, a DSP, an ASIC, an FPGA, or another programmable logic device, discrete gate or transistor logic, discrete hardware components, or any combination of the above, designed to perform the functions described herein. A general-purpose processor may be a microprocessor, but alternatively, a processor may be any conventional processor, a controller, a microcontroller, or a state machine. A processor may also be implemented as a combination of computing devices, for example, a combination of a DSP and a microprocessor, a plurality of microprocessors, one or more microprocessors associated with a DSP core, or a combination of other configurations.

In a firmware or software implementation, the techniques may be implemented as instructions stored on a computer-readable medium such as a random access memory, a read-only memory, a non-volatile RAM, a PROM, an EPROM, an EEPROM, a flash memory, a compact disc, a magnetic or optical data storage device, and the like. The instructions may be executed by one or more processors, which may cause the processor(s) to perform certain aspects of the functions described in the present disclosure.

Although the embodiments described above illustrate the subject matter of the present disclosure being used in one or more standalone computer systems, the present disclosure is not limited thereto and may be implemented in connection with any computing environment, such as a network or a distributed computing environment. Furthermore, the subject matter of the present disclosure may be implemented in multiple processing chips or devices, and storage may likewise be affected across multiple devices. Such devices may include personal computers, network servers, and mobile devices.

Although the present disclosure has been described in connection with certain embodiments, a person of ordinary skill in the technical field to which the present disclosure pertains may make various modifications and changes without departing from the scope of the present disclosure. Furthermore, such modifications and changes must be regarded as within the scope of the claims appended to the present specification.

What is claimed is:

1. A method performed by an apparatus, the method comprising:
acquiring information associated with a first transaction that corresponds to a transfer of a first target digital asset from a first digital wallet to a second digital wallet;
based on the information associated with the first transaction, outputting, via a user interface of the apparatus, a first node corresponding to the first digital wallet, a second node corresponding to the second digital wallet, and a first edge corresponding to the first transaction;
outputting, via the user interface, a second edge corresponding to a second transaction satisfying a predetermined condition, among one or more transactions that correspond to one or more transfers of a digital asset from the second digital wallet to a digital wallet different from the second digital wallet; and
outputting, via the user interface, a third node corresponding to a third digital wallet that is a recipient of the second transaction,
wherein the second transaction is a transaction determined to correspond to a transfer of a second target digital asset associated with at least a portion of the first target digital asset.

2. The method of claim 1, wherein the acquiring the information associated with the first transaction comprises receiving, via the user interface, a user input that indicates the information associated with the first transaction.

3. The method of claim 1, wherein the second transaction is a transaction determined by a machine learning model, by inputting a feature of the third digital wallet into the machine learning model, to transfer a digital asset associated with at least a portion of the first target digital asset to the third digital wallet, and wherein the machine learning model is trained to:
receive a feature regarding a particular recipient that receives a digital asset through a particular transaction from a sender holding a tracking target digital asset; and
output an inference result determining whether the particular transaction corresponds to a transfer of a digital asset associated with at least a portion of the tracking target digital asset, based on the feature regarding the particular recipient.

4. The method of claim 3, wherein the feature regarding the particular recipient comprises information indicating at least one of a quantity of a digital asset transferred to the particular recipient, a quantity of a digital asset transferred from the particular recipient to another digital wallet, an occurrence time of a transaction that corresponds to transferring a digital asset to the another digital wallet, a type of a digital asset transferred by or transferred to the particular recipient, or whether the particular transaction is an external transaction.

5. The method of claim 3, wherein the machine learning model is further trained to output a feature attribution that corresponds to an extent to which the feature regarding the particular recipient contribute to the inference result, and
wherein the method further comprises outputting, via the user interface, a feature, of the third digital wallet, that has a feature attribution output by the machine learning model, among features of the third digital wallet, wherein the feature attribution of the output feature of the third digital wallet satisfies a threshold.

6. The method of claim 5, wherein the outputting the feature of the third digital wallet comprises outputting, via the user interface, the feature attribution satisfying the threshold, together with the feature of the third digital wallet.

7. The method of claim 1, wherein, in response to determining that the third digital wallet is an exchange hot wallet, tracking of the digital asset is stopped for an asset transfer path that includes the third digital wallet.

8. The method of claim 7, wherein whether the third digital wallet corresponds to the exchange hot wallet is determined based on category information of the third digital wallet, and the category information of the third digital wallet is determined by using a data set that includes a plurality of reference wallets and category information regarding the each of the plurality of reference wallets.

9. The method of claim 7, wherein, in response to determining that a number of transactions per unit time, in which the third digital wallet is a recipient or a sender, is at or above a threshold, the third digital wallet is determined to be an exchange hot wallet.

10. The method of claim 1, further comprising:
outputting, via the user interface, an occurrence time of the first transaction and an amount of the first target digital asset, on the first edge; and
outputting, via the user interface, an occurrence time of the second transaction and an amount of the second target digital asset, on the second edge.

11. The method of claim 1, wherein the second transaction comprises a plurality of transactions, and wherein the method further comprises:
outputting, via the user interface, a number of the plurality of transactions on the second edge;
receiving, via the user interface, a user input that selects the second edge;
in response to receiving the user input, outputting, via the user interface, a plurality of sub-edges associated with the plurality of transactions; and
outputting, via the user interface, an occurrence time and a transfer amount of each of the plurality of transactions on each of the plurality of sub-edges.

12. The method of claim 1, further comprising:
receiving, via the user interface, a user input that selects the third node; and
in response to receiving the user input that selects the third node, outputting, via the user interface, an activation indicator corresponding to a trading activity level of the third digital wallet.

13. The method of claim 12, wherein the activation indicator is determined based on a number of transactions, in which the third digital wallet is a recipient or a sender, occurring in each of a plurality of time intervals, and a higher weight is assigned to the number of transactions in a time interval closer to a current time point among the plurality of time intervals.

14. The method of claim 1, further comprising:
receiving, via the user interface, a user input that requests summary information of an asset transfer path of the first target digital asset; and
in response to receiving the user input that requests the summary information, outputting, via the user interface, a list enumerating digital wallet information on one or more asset transfer paths along which the first target digital asset has been transferred.

15. The method of claim 1, wherein, in response to determining that no transaction that corresponds to a transfer of assets from the third digital wallet to a digital wallet different from the third digital wallet exists, tracking of the digital asset is stopped for an asset transfer path that includes the third digital wallet,
wherein whether a third transaction occurs is monitored, wherein the third transaction corresponds to a transfer of a third target digital asset associated with at least a portion of the second target digital asset from the third digital wallet to a digital wallet different from the third digital wallet, and
wherein the method further comprises, in response to determining, through the monitoring, that the third transaction has occurred, outputting, via the user interface, a third edge corresponding to the third transaction and a fourth node corresponding to a fourth digital wallet that is a recipient of the third transaction.

16. The method of claim 1, further comprising:
receiving, via the user interface, a user input associated with a fourth transaction that corresponds to a transfer of a digital asset from the first digital wallet, the second digital wallet, or the third digital wallet to a fifth digital wallet; and
in response to receiving the user input associated with the fourth transaction, determining that the digital asset transferred to the fifth digital wallet through the fourth transaction is associated with at least a portion of the first target digital asset.

17. The method of claim 16, further comprising:
based on the received user input, outputting, via the user interface, a fourth edge corresponding to the fourth transaction and a fifth node corresponding to the fifth digital wallet.

18. The method of claim 16, wherein information associated with the fourth transaction is included in training data for a machine learning model after being assigned with a correct label corresponding to a transaction that requests transferring a tracking target digital asset, and wherein the machine learning model is trained to:
receive a feature regarding a particular recipient that receives a digital asset through a particular transaction from a sender holding the tracking target digital asset; and
output an inference result determining whether the particular transaction corresponds to a transfer of at least a portion of the tracking target digital asset, based on the feature regarding the particular recipient.

19. A non-transitory computer-readable recording medium storing instructions that, when executed, cause:
acquiring information associated with a first transaction that corresponds to a transfer of a first target digital asset from a first digital wallet to a second digital wallet;
based on the information associated with the first transaction, outputting, via a user interface of the apparatus, a first node corresponding to the first digital wallet, a second node corresponding to the second digital wallet, and a first edge corresponding to the first transaction;
outputting, via the user interface, a second edge corresponding to a second transaction satisfying a predetermined condition, among one or more transactions that correspond to one or more transfers of a digital asset from the second digital wallet to a digital wallet different from the second digital wallet; and
outputting, via the user interface, a third node corresponding to a third digital wallet that is a recipient of the second transaction,
wherein the second transaction is a transaction determined to correspond to a transfer of a second target digital asset associated with at least a portion of the first target digital asset.

20. A computing device comprising:
a memory; and
at least one processor coupled to the memory and executing at least one computer- readable program contained in the memory,
wherein the at least one computer-readable program is configured, when executed by the at least one processor communicating with the memory, to cause the computing device to:
acquire information associated with a first transaction that corresponds to a transfer of a first target digital asset from a first digital wallet to a second digital wallet;
based on the information associated with the first transaction, output, via a user interface, a first node corresponding to the first digital wallet, a second node corresponding to the second digital wallet, and a first edge corresponding to the first transaction;
output, via the user interface, a second edge corresponding to a second transaction, among one or more transactions that correspond to a transfer of a digital asset from the second digital wallet to a digital wallet different from the second digital wallet, wherein the second transaction satisfies a predetermined condition; and
output, via the user interface, a third node corresponding to a third digital wallet that is a recipient of the second transaction,
wherein the second transaction is a transaction determined to correspond to a transfer of a second target digital asset associated with at least a portion of the first target digital asset.
